(19) United States
(12) Patent Application Publication
(10) Pub. No.: US 2011/0213476 A1
(43) Pub. Date: Sep. 1, 2011

(54) Method and Device for Processing Audio Data, Corresponding Computer Program, and Corresponding Computer-Readable Storage Medium

(76) Inventor: Gunnar Eisenberg, Brieselang (DE)

(21) Appl. No.: 13/036,690

(22) Filed: Feb. 28, 2011

(30) Foreign Application Priority Data
Mar. 1, 2010 (DE) 102010009745.4

(51) Int. Cl. G06F 17/00

(52) U.S. Cl. 700/94

(57) ABSTRACT

In a method, device, computer program, and computer-readable storage medium for processing audio data, which may be implemented in particular in the field of audio processing, M user parameters are entered into a conversion module, the M user parameters are mapped onto N technical parameters by means of artificial intelligence in the conversion module, the N technical parameters are delivered to some audio equipment, audio data is processed in the audio equipment with the N technical parameters into an output signal, and the output signal is delivered from the audio equipment.

This application claims priority under 35 U.S.C. §119 to German Patent Application No. DE 10 2010 009745.4, filed on 1 Mar. 2010, which is incorporated herein by reference for all purposes.

### BACKGROUND

1. Field of the Application

The present application relates to a method and a device for processing audio data, as well as, to a corresponding computer program and a corresponding computer-readable storage medium, which may be implemented, in particular, in the field of audio processing.

2. Description of Related Art

Known equipment in the recording studio technique, such as synthesizers and audio effect equipment, have user interfaces, which are designed individually depending on the equipment. At such user interfaces, parameters of algorithms used for audio processing are accessible directly as technical parameters (frequencies, amplitudes, spectra, durations, factors, addends, etc.). However, this established concept has the disadvantage that for the control, a user has to muster a high degree of technical understanding, as he or she will be confronted with a multitude of technical parameters (usually within the range from 50 to 150), the effect of which is often predictable only with in-depth technical knowledge. Here, it is to be noted that equipment of the recording studio technique is very frequently to be controlled by musicians and not only technicians. Also, due to the individual design of the user interfaces, the user respectively has to get acquainted again with the control of each piece of equipment, which may be very tedious and time-consuming.

A special field of the recording studio technology is, for instance, the so-called resynthesis. In resynthesis, an input signal (e.g. a sound or noise) is reduced via a mathematical transformation norm in an analyzing step to a weighted sum of base functions. In a consecutive resynthesizing step, the original signal can be reassembled from this weighted sum. Manipulation of the analysis results allows for individual signal aspects to be modified specifically, which is why resynthesis is useful.

As base functions, for instance simple sine waves of different frequencies can be chosen, the amplitudes of which are possibly manipulated, so as to amplify or attenuate individual frequencies.

As base functions, it is also possible for instance to use simple grains or wavelets of different extent and structure so as to amplify or attenuate individual characteristics in the frequency and time domain of the signal.

In recording studio technique, the methods are adapted for filtering, but also for equalizers or noise suppression. The existing technique for resynthesizing sounds is based either on filter banks or on FFT or wavelet transformation. Standard techniques in this respect being vocoders, phase vocoders, as well as sine models, respectively with or without a transient/noise component.

Inherent to all of these techniques for resynthesis is the problem that once a sound has been analyzed, a multitude of parameters (e.g. about 100 to 9000) are available as time-variant signals required for resynthesis. This multitude of parameters can hardly be edited manually anymore, so that most resynthesis systems are closed systems. This is also one of the reasons why the algorithms extensively studied in research are hardly put into practice.

The following known systems deal with the above-mentioned fields of the recording studio technique.

The program Live® by Ableton® is a music sequencer with integrated synthesizers and effect equipment. In order to keep the user interface simple, there is the possibility of assigning to each piece of audio equipment eight macro parameters mapping prominent technical parameters. The association of individual parameters into macro parameters is only possible to a limited extent. In particular, the entire parameter conversion is done purely manually. The resynthesis functionality existing in the program is realized as a black box, so that there is no possibility of intervention for the user.

The systems Kore 1® and Kore 2® by Native Instruments® are synthesizers and effect equipment, the technical parameters of which can also be controlled by eight macro parameters. For this purpose, the internal technical parameters may be associated manually via any type of network. Again, such systems have no automation. There is no possibility for resynthesis.

The program Alchemy® by Camel Audio® is a synthesizer and effect equipment, the technical parameters of which can in principle be managed by macro parameters just like by the Kore® systems by Native Instruments®. With the extensive resynthesis options, it is indeed possible to edit the technical analysis/resynthesis parameters created during the resynthesis process, but only manually and directly as technical parameters.

The program Spectral Delay® by Native Instruments® is a piece of effect equipment performing resynthesis by FFT. During the process of resynthesis, thereby 6144 technical analysis/resynthesis parameters are created as spectral data, which can be edited via a graphical user interface. However, herein, processing is done individually and purely manually for each parameter.

The Neuron® synthesizer by Hartman Music® allows for resynthesis of sounds by means of neural networks. Here, the neural networks are used as a transformation norm in order to store the sounds. The individual parameters required for resynthesis are represented directly in the user interface, so that the system may indeed be operated by neural network specialists, but hardly by the average musician. The system does not have any macro parameters or automation to help the user with control of the core technique.

Thus, in the processing of audio data, as it is implemented for instance in the recording studio technique, very frequently the problem arises that a user is confronted with a multitude of parameters, which are not directly obvious for him, as for this purpose, specific technical knowledge is required. Also, it is often the large number of parameters as such which prevents the user from doing an efficient, purposeful job.

Although great strides have been made in the area of processing audio data, many shortcomings remain.

### DESCRIPTION OF THE DRAWINGS

FIG. 1 shows the principle of parameter conversion according to the invention.

FIG. 2 shows a resynthesis device based on parameter conversion of FIG. 1.

### DETAILED DESCRIPTION OF THE PREFERRED EMBODIMENT

According to the preferred embodiment of the present application, mapping M user parameters onto N technical parameters is achieved by means of artificial intelligence. For this purpose, a conversion module based on artificial intelligence is provided between the user interface, which will also be called user module hereafter, and the audio equipment as such. Thereby, it is possible to present the user with a clearly arranged number of parameters.

In the user module, any type of parameter, however, specifically technical parameters, and/or musical parameters (tone pitches, loudness levels, tone colors, note values, harmonies, transpositions, etc.) and/or subjective parameters (sad/cheerful, languid/vivid, classical/progressive, etc.) can be used as user parameters. Moreover, it is possible at the user interface to provide preferably only musical and/or subjective parameters to choose from, so that control will be clearly simplified for less technically inclined users. For operation, M user parameters are then selected, and these M user parameters are transformed by parameter conversion into the N technical parameters.

As in the user module, in principle any kind of parameter may be chosen, it is also possible to choose exotic parameters, which are not from the field of music or recording studio technique. In this respect, examples could be parameters from biology or color values from an RGB color space. Thus, in the user module, a plant corresponding to certain biological parameters could be represented, or a color via RGB parameters, which a synesthete will assign to a certain sound. Which specific sound from the audio equipment will eventually be assigned to these parameters can be taught to the artificial intelligence of the conversion module.

The present application allows for any type of user parameter to be used in any number for controlling any equipment. Here, it is possible preferably to choose a few, meaningful parameters (about 10 to 20), so that the user is not overwhelmed by too many technical parameters (about 50 to 150). Therefore, according to a preferred embodiment of the present application, M<N.

The M parameters of the user module can be specified by the manufacturer of the synthesizer or effect equipment. If the equipment to be connected to the parameter conversion is also specified, then the training of the artificial intelligence can be entirely factory-set, so that the user does not have to be confronted therewith. If the equipment to be connected to the parameter conversion is to be chosen freely, then the artificial intelligence has to be trained for each piece of equipment at user level.

However, this process may be automated, so that the user does not necessarily have to have professional knowledge about the internal sequences of the training. For this purpose, the N dimensional space formed by the N technical parameters will be scanned, with each point in the space corresponding to one parameter set. The sound generated by each parameter set in the audio equipment is then assigned by the method of sound classification to a sound class, which in turn is fixedly associated with a set of M user parameters specified at factory level. This set of M user parameters can then be associated during training of the artificial intelligence with the matching parameter set of the N technical parameters.

In principle, the M parameters of the user module can also be chosen and designated by the user himself regarding number and type, however, thereafter, the artificial intelligence has to be retrained with the newly defined parameters.

It would also be possible to envisage a user interface, which regarding the parameters thereof would be fundamentally defined by the manufacturer, however, from which any parameter could be displayed or masked by the user. Thus, training of the artificial intelligence by the manufacturer would be possible, but the user would still be able to configure the user interface largely himself, without having to retrain the artificial intelligence.

In particular, the present application also allows for user modules to be provided uniformly for different equipment, as by means of the artificial intelligence implemented according to the present application, standardized parameter conversion can take place. In other words, the user parameters for all of the equipment used could be the same, so that for instance a single user module may be used for all available synthesizers. This also applies for instance for effect equipment and other equipment of the recording studio technique. According to the present application, a conversion module based on artificial intelligence will then be used for standardized parameter conversion.

In the case of resynthesis, the conversion module is then provided between the analysis module and a resynthesis module, so that user parameters and time-variant analysis parameters are input into the conversion module. Thereby, the process of resynthesis can be influenced easily by a few M user parameters (e.g. about 10 to 20) in a user module, in that the artificial intelligence will associate the M user parameters with K time-variant analysis parameters into N resynthesis parameters, and thereby transform the same. The present application allows for existing resynthesis algorithms to be controlled with few parameters which in principle may be chosen freely.

The same applies for synthesizing entirely new sounds, without a known target signal being played, i.e. resynthesized. As an analysis signal (input signal), a guitar sound could be used for instance, from which the analysis module will determine K time-variant synthesis parameters. Next, the conversion module can by means of the K synthesis parameters and the M user parameters perform an appropriate synthesis, which makes use of artificial intelligence. Thereby, it is possible to alienate the original guitar sound for instance so that it turns into a mix of piano and flute.

In practice, systems of artificial intelligence (AI) will accept one or more input parameters and will deliver in response one or more output parameters. The input and output are generally done in the form of vectors. Each AI system has to be trained prior to meaningful usage. For this purpose, for one set of input vectors, the respectively correct output vectors must be known. The exact training algorithm depends on the respective structure of the AI system. Upon successful training, the AI system is basically capable of generating the correct output vectors even for unknown input vectors.

The following techniques are used for realizing AI systems.

Symbolic AI
In a descriptive language (e.g. predicate logic or propositional logic), known properties of the system are described with binding rules.
During training, the rules are transformed manually or via a predictive programming language, such as Prolog, so that explicit propositions regarding the treatment of the input data are created.

Statistical AI
Instead of the binding rules of a descriptive language, statistical models (e.g. Gaussian mixture model, hidden Markov model, k nearest neighbor) are used.
The discrete logical values of a descriptive language are replaced by probabilities. They are determined in the training phase by observing the statistical properties of the input vectors.

Neural AI
As a model of biological neurons, artificial neurons are built from simple mathematical operators and associated into very large networks.
The treatment of the parameters entered is mapped via the linking strength of the individual neurons among each other.
The standard structures used here are feed forward, Hopfield and winner takes all, which are mainly trained via the back propagation method.

Modular systems for synthesizers and effect equipment, such as e.g. Reaktor®, SynthMaker® or Tassman®, can be simplified significantly as to the control thereof, in that each individually created piece of audio equipment is standardized by the parameter conversion of the invention. The same applies for the control data in sequencing programs, such as e.g. Logic®, Cubase®, or Live®.

Any type of sound can be reduced by the resynthesis-assisted AI of the present invention to models and edited and transformed via uniform, simple user parameters. This gives musicians access to the field of complex mathematical transformations because the control is similar as for known samplers, such as e.g. Kontakt® or Logic EXS24®, with the resulting sounds of the invention however largely exceeding those of known samplers.

Hereafter, the invention will be explained more in detail with reference to the figures using various sample embodiments.

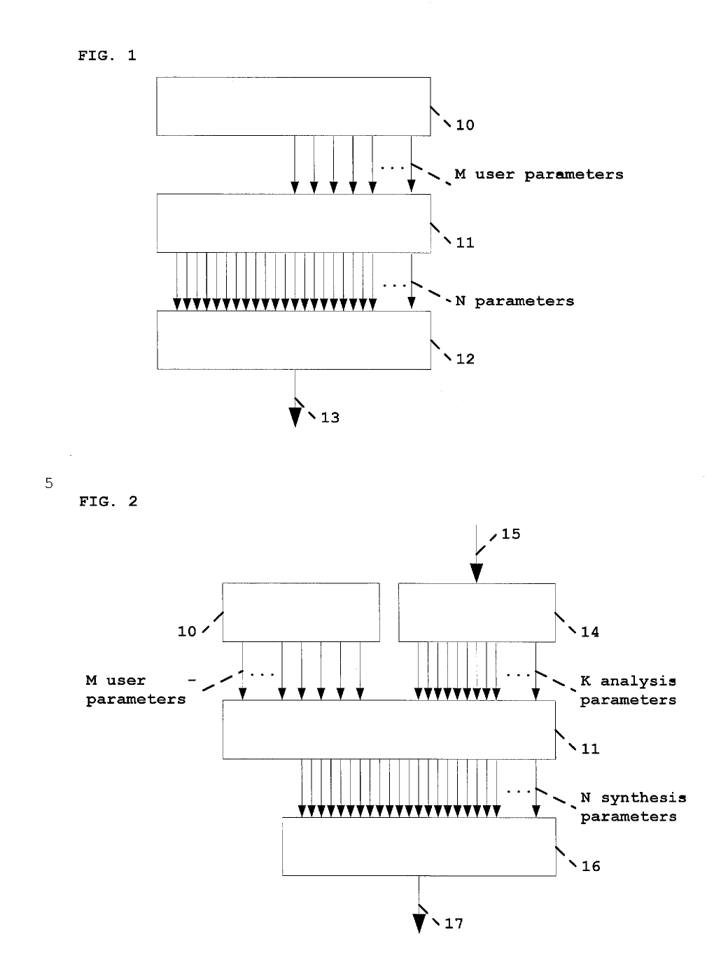

By means of FIG. 1, the principle of parameter conversion, on which the invention is based, will be described. FIG. 1 illustratively shows a piece of equipment of the recording studio technique, or part thereof, composed of three modules. In this case, the three modules can be realized as different hardware or in one piece of hardware, in which the three modules are logically separated from each other.

A user module (user interface) 10 provides a user with selection of user parameters from which the user selects M parameters. These M user parameters are then supplied to a conversion module 11, which maps the M user parameters by means of artificial intelligence onto N technical parameters. These N technical parameters, the number of which, according to a preferred embodiment of the invention, is notably greater than the number of the M user parameters, are entered into some audio equipment 12. The audio equipment processes audio data and/or audio control data with the N technical parameters into an audio signal 13 and outputs the same.

The audio data may already be stored in the audio equipment 12. It is also possible that audio control data, such as e.g. MIDI data, from one or more pieces of external equipment (not shown), such as e.g. MIDI keyboards, is entered into the audio equipment 12 for manipulating the audio data stored therein. Furthermore, it is possible that the audio data or part of the audio data from one or more pieces of external equipment (not shown), such as e.g. other synthesizers, is entered into the audio equipment 12. The so-called external equipment may be contained inside the audio equipment itself and be realized as logically separate modules, as for instance in keyboard work stations, or as stand-alone hardware devices be separated from the audio equipment. The audio equipment may for instance be a stand-alone rack synthesizer or a software plug-in.

With reference to FIG. 2, a resynthesis device will be described, which is based on the principle of parameter conversion according to the present application. The resynthesis device may for instance be part of some equipment of the recording studio technique or be embodied as some stand-alone equipment.

The resynthesis device has an analysis module 14, into which an input signal 15 is entered. This input signal may be single-channel (mono), dual-channel (stereo), or multi-channel (e.g. Dolby Surround®, DTS®). The input signal 15 is analyzed by the analysis module 14 in order to determine K time-variant analysis parameters therefrom. For instance, the input signal is subjected to a specific transformation, resulting in the K time-variant analysis parameters. These K time-variant analysis parameters are in addition to the M user parameters from the user module 10 entered into the conversion module 11. The conversion module 11 will then map the M user parameters and the K analysis parameters by means of artificial intelligence onto N technical parameters, which in this particular case of resynthesis may also be called resynthesis parameters. These N resynthesis parameters are then used in a resynthesis module 16 for generating an output signal 17.

In the two sample embodiments described for parameter conversion and resynthesis, respectively one audio signal 13, 17 is output. This output signal may be single-channel (mono), dual-channel (stereo) or multi-channel (e.g. Dolby Surround®, DTS®).

It will be appreciated that the method of the present application, including one or more of the steps, may be carried out by a data processing system having a microprocessor, memory, and a storage means, and a computer program loaded into the storage means, wherein at least the mapping the M user parameters onto N technical parameters is carried out by the computer program. In addition, the steps and procedures of the present application may be performed manually or automatically in response to selected criteria.

Furthermore, the method of the present application may be utilized in the form of a computer-readable storage medium on which a computer program is stored that enables a data processing system, such as the data processing system described above.

It is apparent that an invention with significant advantages has been described and illustrated. The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified, and all such variations are considered within the scope and spirit of the invention. Accordingly, the protection sought herein is as set forth in the description. Although the present application is shown in a limited number of forms, it is not limited to just these forms, but is amenable to various changes and modifications without departing from the spirit thereof.

I claim:

1. A method for processing audio data, comprising:
inputting M user parameters as an input signal into a conversion module;
mapping the M user parameters onto N technical parameters by means of artificial intelligence in the conversion module;
delivering the N technical parameters to audio equipment;
processing audio data in the audio equipment with the N technical parameters into an audio output signal; and
delivering the audio output signal from the audio equipment.

2. The method according to claim 1, wherein M<N.

3. The method according to claim 1, wherein the audio data is entered into the audio equipment.

4. The method according to claim 1, further comprising:
an analysis module;
wherein the input signal is entered into the analysis module, the analysis module determines K analysis parameters from the input signal, and the K analysis parameters are entered into the conversion module.

5. The method according to claim 4, wherein the conversion module maps the M user parameters and the K analysis parameters onto the N technical parameters.

6. The method according to claim 5, wherein the N technical parameters are synthesis parameters, and the audio equipment performs a synthesis.

7. The method according to claim 5, wherein the analysis module performs a transformation of the input signal, resulting in K analysis parameters, the conversion module transforms the K analysis parameters based on the M user parameters into N resynthesis parameters, and the audio equipment generates the audio output signal based on the N resynthesis parameters.

8. The method according to claim 1, wherein the conversion module is trained in an automated process.

9. The method according to claim 1, further comprising:
a data processing system having a microprocessor, memory, and a storage means;
a computer program loaded into the storage means;
wherein at least the mapping the M user parameters onto N technical parameters is carried out by the computer program.

10. A device for processing audio data, comprising:
a user module for providing user parameters from which a user may choose;
a conversion module for receiving M user parameters from the user module and for mapping the M user parameters by means of artificial intelligence onto N technical parameters; and
audio equipment for receiving the N technical parameters from the conversion module, for processing audio data with the N technical parameters into an output signal and for delivering the output signal.

11. The device according to claim 10, wherein M<N.

12. The device according to claim 10, further comprising:
one or more pieces of external equipment for providing the audio equipment with the audio data.

13. The device according to claim 10, further comprising:
an analysis module for determining from an input signal K analysis parameters and for inputting the K analysis parameters into the conversion module.

14. The device according to claim 10, wherein the conversion module is based on algorithms from at least one of symbolic artificial intelligence, neural artificial intelligence, and statistical artificial intelligence.
